(19) United States
(12) Patent Application Publication
(10) Pub. No.: US 2005/0238471 A1
(43) Pub. Date: Oct. 27, 2005

(54) Wheelchair lift

(75) Inventors: Karapet Ablabutyan, Glendale, CA (US); Parkev Krmoian, Glendale, CA (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: MAXON LIFT CORPORATION

(21) Appl. No.: 10/954,697

(22) Filed: Sep. 29, 2004

Related U.S. Application Data
(63) Continuation-in-part of application No. 10/251,433, filed on Sep. 20, 2002, now Pat. No. 6,705,824.
Application No. 10/251,433 is a continuation of application No. 09/675,318, filed on Sep. 29, 2000, now Pat. No. 6,461,097.

(51) Int. Cl. B60P 1/00

(52) U.S. Cl. 414/546

(57) ABSTRACT

A wheelchair lift having a logic module which provides several interlocks that promote proper operation is described. Also, a wheelchair lift having an arm geometry which requires a lower peak force for operation is described.

### CROSS-REFERENCE TO RELATED APPLICATIONS

This application is a continuation-in-part of U.S. patent application Ser. No. 10/251,433 filed on Sep. 20, 2002 entitled “Wheelchair Lift Device”, which is a continuation of U.S. patent application Ser. No. 09/675,318 filed on Sep. 29, 2000 entitled “Wheelchair Lift Device”, now U.S. Pat. No. 6,461,097, each of which are incorporated by reference herein.

### FIELD OF THE INVENTION

The present invention is directed to a wheelchair lift. More specifically, the present invention is directed to a wheelchair lift with interlocks that promote proper operation. The present invention is also directed towards a wheelchair lift which requires a lower peak force for operation.

### BACKGROUND OF THE INVENTION

Wheelchair lifts raise and lower a wheelchair and/or passenger to and from vehicles. Wheelchair lifts are typically mounted in a doorway of a vehicle and have a platform that raises and lowers the wheelchair and/or passenger between the ground and the vehicle. A common wheelchair lift design is a parallelogram design which uses two sets of lift arms arranged in a parallelogram or near-parallelogram arrangement on either side of the platform.

Wheelchair lifts may cause injuries to people and damage to vehicles if not operated properly. For example, operating a wheelchair lift while the vehicle is in motion can be dangerous.

Wheelchair lifts may use hydraulic actuators to provide the lifting force to move the platform. In certain situations, the use of electric actuators may provide certain features which are desirable to wheelchair lifts. For example, electric actuators may provide variable speed control. However, an electric actuator of a given force rating will cost more than a hydraulic actuator of the same force rating.

What is needed is a wheelchair lift with interlocks that promote proper operation. What is also needed is a wheelchair lift which requires a lower peak force for operation, to permit the practical use of electric actuators.

### BRIEF DESCRIPTION OF THE DRAWINGS

FIG. 1A shows one embodiment of a wheelchair lift in accordance with the present invention.

FIG. 1B-1F show the wheelchair lift in a ground, intermediate, floor level, partially stowed, and fully stowed positions.

FIG. 2 shows one embodiment of a remote control pendant that may be used with the wheelchair lift.

FIGS. 3A-3B show a prior art arm geometry for a wheelchair lift.

FIGS. 3C-3D show one embodiment of an arm geometry in accordance with the present invention.

FIG. 3E shows a graph of actuator force required for a prior art arm geometry and an arm geometry in accordance with the present invention.

### DETAILED DESCRIPTION OF PREFERRED EMBODIMENTS OF THE INVENTION

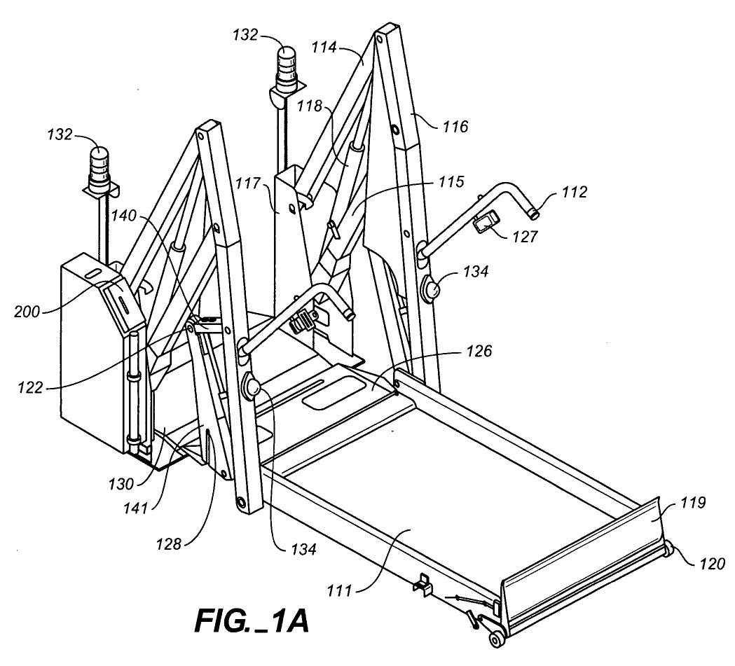

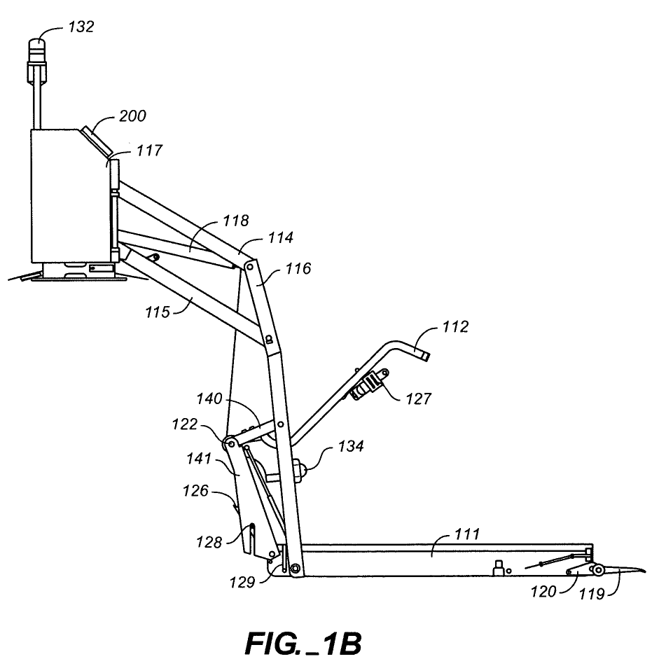

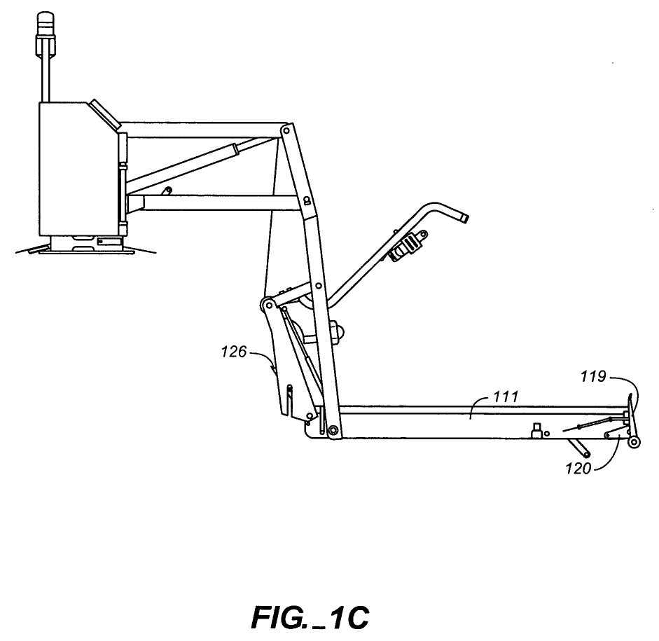

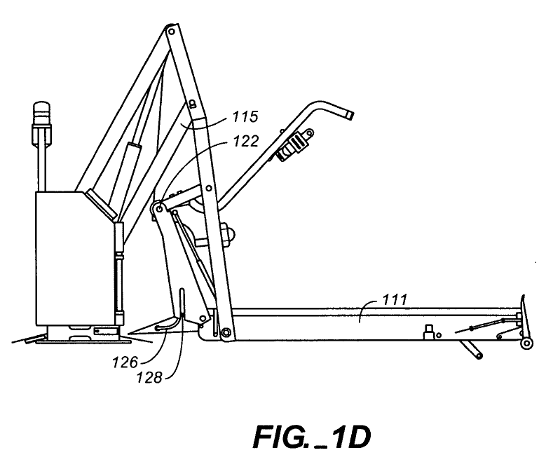

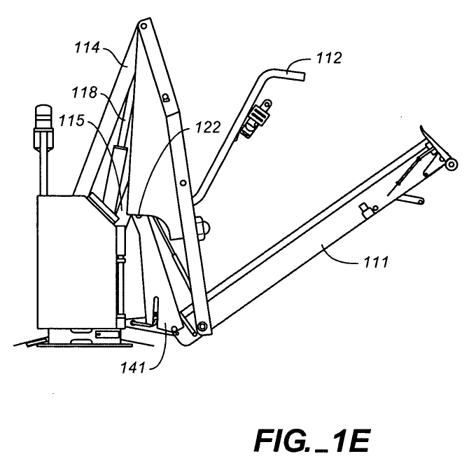

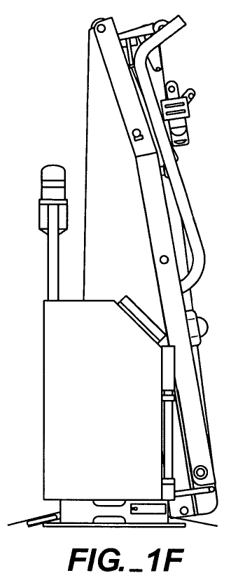

FIG. 1A shows one embodiment of a wheelchair lift 100 in accordance with the present invention. Wheelchair lift 100 includes an upper arm 114 and a lower arm 115 coupled to a frame 117 and a vertical arm 116. The points where upper arm 114 and lower arm 115 couple to frame 117 and vertical arm 116 may form the points of a parallelogram or a near-parallelogram. A lift actuator 118 is coupled to the point where upper arm 114 couples to vertical arm 116 and to the point where lower arm 115 couples to frame 117. Frame 117 is designed to be coupled to a vehicle, and may include a threshold plate 130.

Wheelchair lift 100 also includes a platform 111 coupled to vertical arm 116. Platform 111 is kept in a substantially level position by a platform stop 129 which rests against vertical arm 116. An inboard roll stop 126 and an outboard roll stop 119 are coupled to platform 111. A stow linkage is also coupled to platform 111, the stow linkage having an upper stow arm 140, a lower stow arm 141, and a roller 122. An inboard roll stop actuator 128 is coupled to inboard roll stop 126 and lower stow arm 141. A handrail 112 is coupled to upper section 141 of the stow linkage. A restraint belt 127 is attached to handrail 112. An outboard roll stop linkage 120 is coupled to outboard roll stop 119.

A logic module 200 provides several interlocks that promote the proper operation of wheelchair lift 100. Logic module 200 is described in greater detail below. A visual alarm 132 provides a visual alert when wheelchair lift 100 is in use. In a preferred embodiment, two visual alarms 132 are coupled to frame 117, or otherwise coupled directly to wheelchair lift 100. Audio alarms such as a siren or buzzer provide audible alerts that wheelchair lift 100 is in use, or if there is a condition preventing wheelchair lift 100 from being operated. A platform light 134 attached to vertical arm 116 illuminates platform 111 when wheelchair lift 100 is used in poor light conditions. In a preferred embodiment, two platform lights 134 are connected to each vertical arm 116, or otherwise coupled directly to wheelchair lift 100.

FIG. 1B shows wheelchair lift 100 in a ground position. Platform 111 is near or at ground level. Outboard roll stop 119 is lowered when outboard roll stop linkage 120 contacts the ground, thus allowing the passenger to board platform 111. Inboard roll stop 126 is raised and prevents the passenger from traveling off platform 111.

FIG. 1C shows wheelchair lift 100 in an intermediate position after it has begun to lift from the ground position. Outboard roll stop 119 is raised as outboard roll stop linkage 120 lifts off the ground and no longer contacts the ground, thus preventing the passenger from traveling off platform 111. Inboard roll stop 126 is still raised.

FIG. 1D shows wheelchair lift 100 in a floor level position. Platform 111 is at the level of the vehicle. Inboard roll stop actuator 128 lowers inboard roll stop 126 and allows the passenger to board the vehicle. Outboard roll stop 119 is still raised.

FIG. 1E shows wheelchair lift 100 as it is folding into a stowed position. Lift actuator 118 continues to raise upper arm 114 and lower arm 115. After platform 111 lifts a small distance, roller 122 begins to push against lower arm 115, and upper stow arm 140 and lower stow arm 141 straighten out and begin to raise platform 111 into a stowed position. Handrails 112 also begin to raise into a stowed position.

FIG. 1F shows wheelchair lift 100 in the fully stowed position. Platform 111 is now in an upright position. Hooks or latches may prevent platform 111 from shaking or rattling while in the stowed position.

As mentioned above, logic module 200 provides several interlocks that promote the proper operation of wheelchair lift 100. Logic module 200 is capable of receiving feedback from various sensors located throughout wheelchair lift 100 and controlling the operation of wheelchair lift 100 accordingly. Logic module 200 is connected to sensors which detect the positions of platform 111, upper arm 114, lower arm 115, inboard roll stop 126, inboard roll stop actuator 128, outboard roll stop 119, and threshold pressure plate 130. These sensors may include ammeters, voltmeters, limit switches, weight sensors, optical sensors, ultrasound sensors, pressure mats, pressure switches, pressure transducers, and any other suitable sensors. Logic module 200 includes a microprocessor and software, and uses data from these sensors to control lift actuator 118 and inboard roll stop actuator 128. Logic module 200 may also detect faulty connections to lift actuator 118 and inboard roll stop actuator 128.

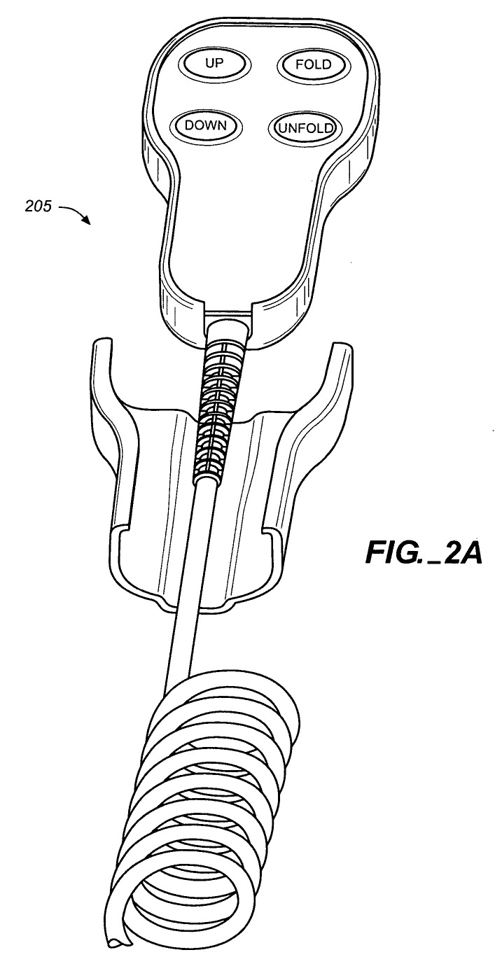

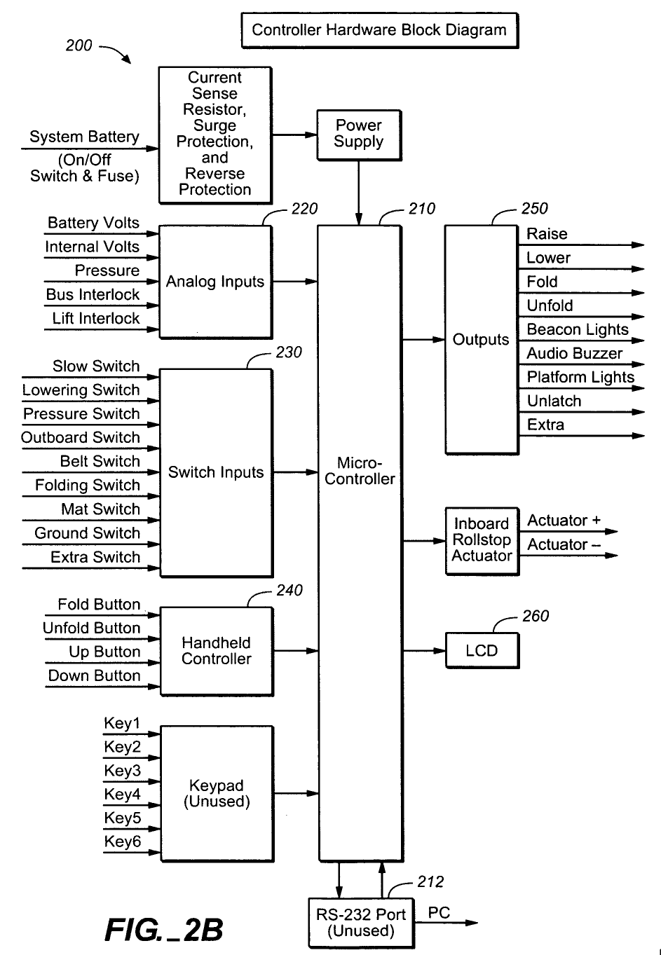

FIG. 2A shows one embodiment of a control pendant 205 in accordance with the present invention. Control pendant 205 is connected to logic module 200, and provides four functions which allow a user to operate wheelchair lift 100: UP, FOLD, UNFOLD, and DOWN. UP raises wheelchair lift 100 from the ground position to the floor level position. FOLD stows wheelchair lift 100 from the floor level position into the stowed position. UNFOLD unstows wheelchair lift 100 from the stowed position to the floor level position. DOWN lowers wheelchair lift from the floor level position to the ground position. Logic module 200 allows only the appropriate commands to performed, depending on the position of wheelchair lift 100. For example, in the ground position, only the UP command is available. Below the floor level position, only the UP and DOWN commands are available. In the floor level position, only the DOWN and FOLD commands are available. In the stowed position, only the UNFOLD command is available. The available command choices for a given position may be indicated by the user interface, for example, by illuminated buttons. Logic module 200 may stop wheelchair lift 100 if more than one button is pressed at a time on control pendant 205.

Logic module 200 is capable of sending an interlock signal to the vehicle which is capable of interacting with the vehicle to prevent forward and rearward movement of the vehicle when wheelchair lift 100 is not in the stowed position. Logic module 200 is also capable of preventing unstowing and/or operation of wheelchair lift 100 unless an interlock signal is received from the vehicle, indicating, for example, that the vehicle transmission is in the park position and the vehicle parking brake has been set. Logic module 200 is also capable of stopping wheelchair lift 100 if: wheelchair lift 100 is overloaded, platform 111 is occupied when a FOLD command is received, resistance is encountered when wheelchair lift 100 is being stowed, outboard roll stop 119 is lowered when platform 111 is more than three inches above the ground, restraint belt 127 is not fastened, and threshold plate 130 is occupied when platform 111 is below the floor level position.

Logic module 200 raises and lowers inboard roll stop 126 at the appropriate points during operation of wheelchair lift 100. Before platform 111 is lowered from the floor level position, logic module 200 raises inboard roll stop 126. After platform 111 is raised to the floor level position, logic module lowers inboard roll stop 126. Logic module 200 will check the position of inboard roll stop 126 or inboard roll stop actuator 128 and raise inboard roll stop 126 if necessary before moving platform 111, regardless of the position of platform 111. This prevents inboard roll stop 126 from damaging the vehicle when inboard roll stop 126 is in a partially lowered position after repairs or any other reason while platform 111 is below the floor level position.

Outboard roll stop 119 may raise and lower without an actuator. In this case, logic module 200 may be connected to a separate ground sensor which indicates whether platform 111 is greater than, for example, three inches from the ground. Logic module 200 is capable of stopping platform 111 if outboard roll stop 119 is lowered when platform 111 is greater than, for example, three inches from the ground.

Logic module 200 is capable of preventing wheelchair lift 100 from being stowed when platform 111 is still occupied. As can be seen in FIG. 1D, roller 122 does not yet contact lower arm 115 in the floor level position. A small gap is present between roller 122 and lower arm 115 in the floor level position. When a FOLD command is received, this small gap allows platform 111 to remain substantially level during the initial phase of the stowing operation. During this initial phase of the stowing operation, platform 111 is lifted through a small distance of, for example, one or two inches. This small lifting motion allows logic module 200 to detect weight on platform 111. In one embodiment, logic module 200 detects whether a pressure switch coupled to lift actuator 118 is triggered during this small lifting motion. In another embodiment, logic module 200 detects the amperage required by lift actuator 118 to perform this small lifting motion. If the pressure switch is triggered or an out-of-range amperage is detected, logic module 200 will stop platform 111. The amount of weight on platform 111 necessary to prevent a stowing operation may be set, for example, to 50 pounds. Because of the small initial lifting motion, the position of a weight on platform 111 does not affect this interlock. After a stowing operation is stopped because of a weight on platform 111, logic module 200 may automatically return platform 111 to the floor level position, or require the user to push the DOWN button and return platform 111 to the floor level position. This maintains the small gap between roller 122 and lower arm 115, and prevents the user from overriding this interlock by pressing the FOLD button repeatedly.

FIG. 2B shows one embodiment of a hardware block diagram for a logic module 200 in accordance with the present invention. Logic module 200 includes a micro-controller 210 which receives commands 240 from the user through pendant 205. Micro-controller 210 also receives analog inputs 220 and switch inputs 230. Micro-controller 210 may be capable of communicating with another computer through an interface 212.

BATTERY VOLTS indicates the vehicle battery charge level. Logic module 200 may display a low battery indicator when the vehicle battery charge level is below, for example, 12.4 volts. Logic module 200 may also prevent wheelchair lift 100 from being unstowed or lowered when the vehicle battery charge level is below, for example, 12.2 volts. PRESSURE indicates the pressure from lift actuator 118 in an embodiment where lift actuator 118 is a hydraulic cylinder. BUS INTERLOCK is an indicator from the vehicle to logic module 200 that wheelchair lift 100 can be operated. For example, BUS INTERLOCK may indicate that the vehicle transmission is in the park setting and that the vehicle parking brake has been set. LIFT INTERLOCK is an indicator from logic module 200 to the vehicle that the vehicle can be operated. For example, LIFT INTERLOCK may indicate that wheelchair lift 100 is fully stowed.

STOW SWITCH indicates whether wheelchair lift 100 is in the fully stowed position. STOW SWITCH may be a sensor that detects the position of upper arm 114 and/or lower arm 115. LOWERING SWITCH indicates whether platform 111 is at or below the floor level position. LOWERING SWITCH may be a sensor that detects the position of upper arm 114 and/or lower arm 115. PRESSURE SWITCH indicates whether there is a weight on platform 111 before platform 111 can be stowed. PRESSURE SWITCH may be a pressure switch connected to lift actuator 118 and may be set, for example, to 50 pounds. OUTBOARD SWITCH indicates whether outboard roll stop 119 is raised. BELT SWITCH indicates whether restraint belt 127 has been fastened. FOLDING SWITCH indicates whether platform 111 is above the floor level position. MAT SWITCH indicates whether threshold plate 130 is occupied. GROUND SWITCH indicates whether wheelchair lift 100 is in the ground position. EXTRA SWITCH is reserved for other features or interlocks.

RAISE will raise platform 111. If lift actuator 118 is a hydraulic actuator, logic module 200 will turn on the pump motor for lift actuator 118. LOWER will lower platform 111. If lift actuator 118 is a hydraulic actuator, logic module 200 will open the hydraulic valve for lift actuator 118. FOLD will stow platform 111. If lift actuator 118 is a hydraulic actuator, logic module 200 will turn on the pump motor for lift actuator 118 in series with a resistor to provide a slower rate of motion. UNFOLD will unstow platform 111. If lift actuator 118 is a hydraulic actuator, logic module 200 will open the hydraulic valve for lift actuator 118. BEACON LIGHTS will turn on visual alarm 132 while wheelchair lift 100 is in operation. AUDIO BUZZER will turn on audio alarms while wheelchair lift 100 is in operation and/or if an interlock stops wheelchair lift 100. PLATFORM LIGHTS will turn on platform lights 134 while wheelchair lift 100 is at or below the floor level position. UNLATCH will unlatch hooks which hold wheelchair lift 100 in the stowed position. ACTUATOR+ will raise inboard roll stop 126, while ACTUATOR− will lower inboard roll stop 126.

When a command 240 is received from the user, micro-controller 210 first looks at the state of analog inputs 220 and switch inputs 230 to check that all conditions have been satisfied for the particular command. Only after all the proper conditions have been satisfied for the particular command, will micro-controller 210 send the proper output signals 250 to effect the command. For example, when an UP command is received from the user, micro-controller 210 will first check the inputs to see: (1) whether BUS INTERLOCK indicates that operate wheelchair lift 100 can be operated, (2) whether BATTERY VOLTS indicates there is sufficient battery voltage from the vehicle battery, (3) whether OUTBOARD SWITCH indicates that outboard roll stop 119 is raised when platform 111 is greater than, for example, three inches above the ground, (4) whether inboard roll stop 126 is raised by sending a signal to inboard roll stop actuator 128, (5) whether BELT SWITCH indicates that restraint belt 127 is fastened, and (6) whether MAT SWITCH indicates that threshold plate 130 is not occupied. Only after these conditions for an UP command are satisfied, will micro-controller 210 send the suitable signals that make up an UP command. For example, an UP command may include: (1) turning on BEACON LIGHTS, (2) turning on AUDIO BUZZER, (3) turning on PLATFORM LIGHTS, (4) sending a RAISE output to cause lift actuators 118 to raise platform 111 to the floor level position, (5) sending an ACTUATOR-output to lower inboard roll stop 126, and (6) turning off AUDIO BUZZER.

Logic module 200 may also be programmed to provide additional features which enhance the operation of wheelchair lift 100. For example, where lift actuators 118 are hydraulic actuators, logic module 200 may be programmed to run the pump motors for lift actuators 118 for a small additional period of time after wheelchair lift 100 is fully stowed. This has the effect of pressurizing lift actuators 118 and minimizing or preventing rattling of wheelchair lift 100 in the stowed position. Logic module 200 may also be programmed to pressurize hydraulic actuators at certain time intervals or upon certain events to keep lift actuators 118 pressurized when wheelchair lift 100 is not being used. For example, logic module 200 may pressurize hydraulic actuators every time the vehicle is started, or use pressure sensor feedback to pressurize hydraulic actuators when the pressure has dropped below a certain value.

Logic module 200 may be programmed to shut off wheelchair lift 100 if an out-of-range voltage is detected, thus acting as a programmable fuse to prevent damage to wheelchair lift 100.

Logic module 200 is capable of preventing wheelchair lift 100 from being operated when the vehicle battery charge level has dropped too low to prevent the vehicle battery from being drained to a point where the vehicle cannot start.

Logic module 200 is capable of recording the number of lift cycles and stow cycles. The definition of a lift cycle and a stow cycles may be changed as needed. For example, a lift cycle may be defined as one full trip from the ground position to the floor level position, regardless of how far platform 111 has actually traveled. Logic module 200 may also be capable of calculating the total amount of work performed by wheelchair lift 100, given the distance traveled by platform 111 and the weight carried.

Logic module 200 includes a visual display 260 for displaying a variety information. Visual display 260 may be an LCD display or any other suitable display. Visual display 260 may assist the user in operation of wheelchair lift 100 by providing instructions, indicating the current command being performed, indicating the current status of wheelchair lift 100, highlighting conditions that must be satisfied before wheelchair lift 100 can be operated, and suggesting certain actions such as starting the engine to recharge the battery. Visual display 260 may assist in the maintenance of wheelchair lift 100 by displaying the number of lift cycles and stow cycles and suggesting maintenance to be performed. Visual display 260 may assist in diagnostics and troubleshooting by, for example, indicating the vehicle battery charge level, indicating temperatures of motors or pumps, and displaying error messages. Visual display 260 may be used during manufacturing, assembly, and maintenance of wheelchair lift 100 to aid in adjustment and calibration of the various components of wheelchair lift 100.

Wheelchair lift 100 may include a battery backup system. The battery backup system allows wheelchair lift 100 to be operated when other sources of power are not available or have failed. The battery backup system exists in addition to a manual backup system, which may include a hand crank, hand pump, or other manually operated devices for operating wheelchair lift 100.

Lift actuator 1 18 may be a hydraulic actuator or an electrical actuator. Electrical actuators include screw drives, rack and pinion drives, and other actuators such as Electrak® ball bearing screw drives manufactured by Danaher Motion Linear Products, Marengo, Ill. The use of electrical actuators allow for variable speed control of the raising and lowering of wheelchair lift 100. Electrical actuators may reduce the number of external sensors needed to determine the position of wheelchair lift 100 by providing feedback from sensors such as integrated potentiometers or optical sensors. The electrical characteristics of electrical actuators may be used to implement interlocks. For example, an out-of-range voltage detected from electrical actuators while platform 111 is being lowered may indicate that an object is obstructing platform 111 from lowering, thus acting as an anti-crushing feature. An out-of-range voltage may also indicate that platform 111 has reached the ground, thus acting as an anti-jacking feature. As another example, an out-of-range voltage detected from electrical actuators while platform 111 is at floor level and while stowing of platform 111 is being attempted may indicate that platform 111 is still occupied, thus acting as an occupied platform interlock. Electrical actuators also allow for control of the wheelchair lift during lowering, instead of relying on the “gravity down” operation of hydraulic actuators. Electrical actuators may also allow wheelchair lift 100 to be held tightly in the stowed position without unstowing, rattling, or shaking. Electrical actuators also provide consistent performance over temperature changes and do not leak.

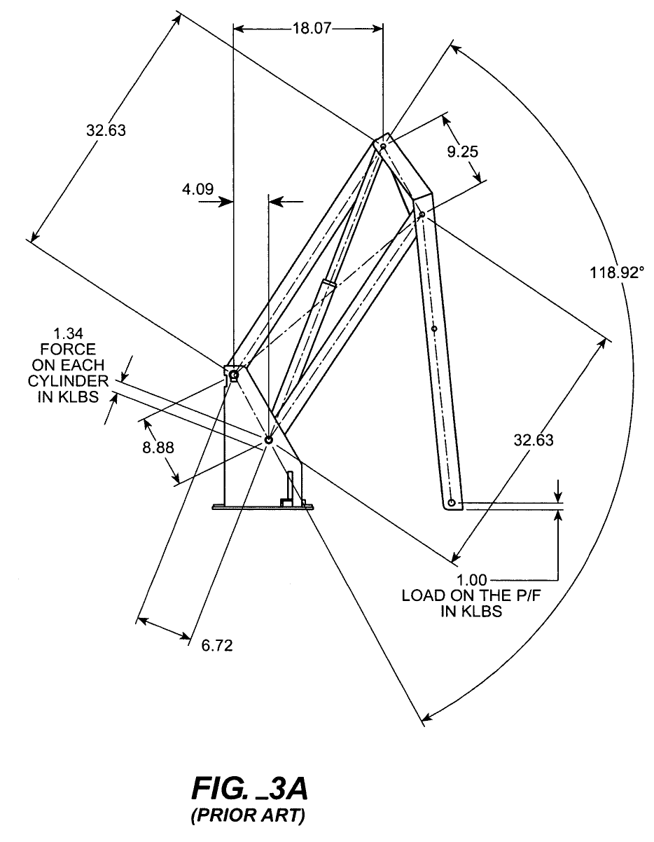

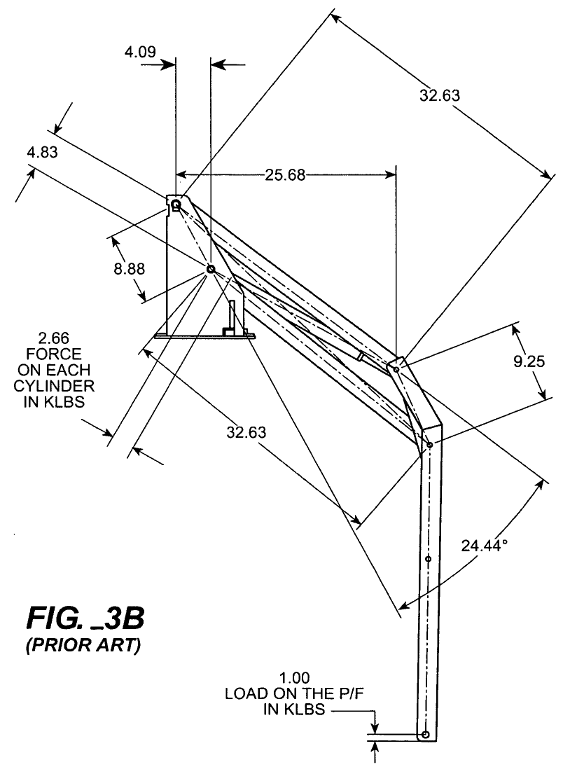

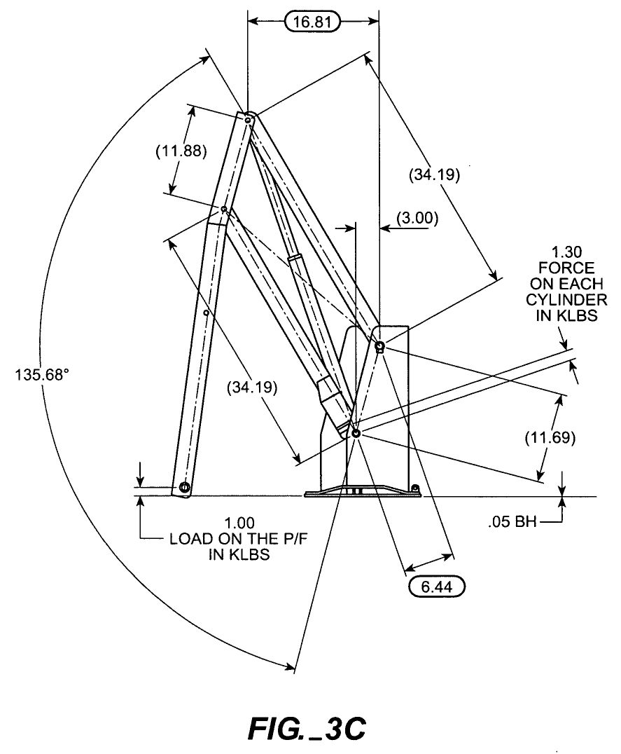

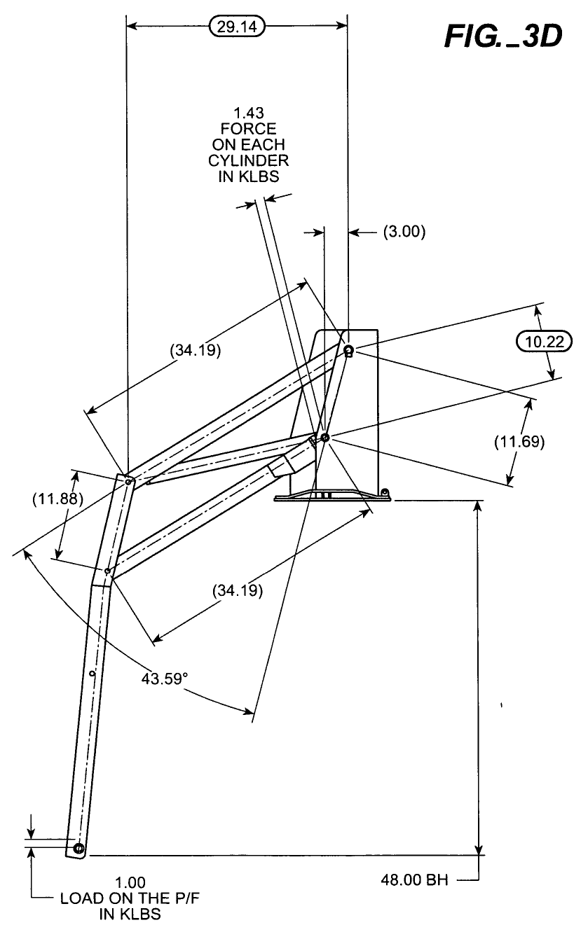

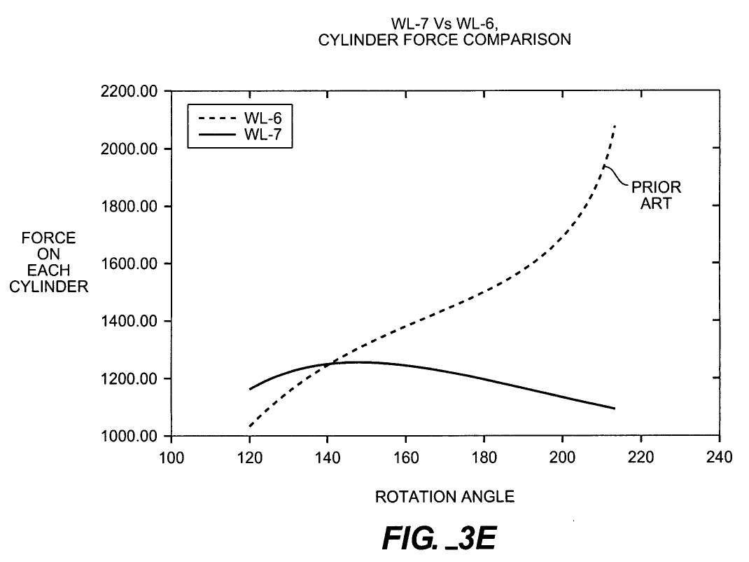

FIGS. 3A-3B show a prior art arm geometry for a wheelchair lift. The prior art geometry is a parallelogram design.

FIGS. 3C-3D show one embodiment of an arm geometry in accordance with the present invention. Upper arm 114 and lower arm 115 couple to frame 117 at two points that are farther apart than in the prior art geometry. In addition, the two points are located along a steeper angle than in the prior art geometry.

This lift arm geometry reduces the distance between the point where upper arm 114 couples to frame 117 and to the point where lower arm 115 couples to vertical arm 116 as the lift arms are passing through a horizontal position.

This lift arm geometry reduces the peak force needed from lift actuator 118. The reduced peak force required makes this lift arm geometry suitable for use with electrical actuators, which may not be able to generate as much force as hydraulic actuators of comparable cost. However, hydraulic actuators may still be used and benefit similarly from this lift arm geometry.

FIG. 3E shows a graph of actuator force required for the prior art arm geometry and an arm geometry in accordance with the present invention. As can be seen, the prior art arm geometry requires an actuator force of more than 2000 pounds when its platform has reached the floor level position. An arm geometry in accordance with the present invention requires an actuator force of less than 1200 pounds when its platform has reached the floor level position, with the maximum force during the lifting of the platform not exceeding 1300 pounds.

Although the above examples have described wheelchair lift 100 in the context of carrying a wheelchair and/or a passenger, wheelchair lift 100 may be used in other applications. Wheelchair lift 100 may be used in the same or modified form to be attached to different parts of a vehicle and to carry other types of payloads.

While the invention is described in terms of some specific examples and embodiments, it will be clear that this invention is not limited to these specific examples and embodiments and that many changes and modified embodiments will be obvious to those skilled in the art without departing from the true spirit and scope of the invention.

1. A wheelchair lift for raising and lowering a passenger between a ground and a bed of a vehicle, the wheelchair lift comprising:
a platform capable of stowing into a stowed position;
a sensor; and
a logic module coupled to the platform and the sensor, the logic module capable of using data from the sensor to provide an interlock that promotes the proper operation of the wheelchair lift.

2. The wheelchair lift of claim 1, wherein the logic module prevents forward and rearward movement of the vehicle when the wheelchair lift is not in the stowed position.

3. The wheelchair lift of claim 1, wherein the logic module prevents unstowing of the wheelchair lift if a transmission of the vehicle is not set in a park position and a parking brake of the vehicle has not been set.

4. The wheelchair lift of claim 1, wherein the logic module stops the wheelchair lift if the platform is overloaded.

5. The wheelchair lift of claim 1, wherein the logic module stops stowing of the wheelchair lift if the platform is occupied.

6. The wheelchair lift of claim 1, wherein the logic module stops stowing of the wheelchair lift if resistance is encountered while the wheelchair lift is being stowed.

7. The wheelchair lift of claim 1, wherein the logic module stops the wheelchair lift if an outboard roll stop is not fully raised when the platform is more than three inches above the ground.

8. The wheelchair lift of claim 1, wherein the logic module prevents the wheelchair lift from being operated if a restraint belt is not fastened but will not stop the wheelchair lift if the restraint belt is unfastened once the wheelchair lift has started to operate.

9. The wheelchair lift of claim 1, wherein the logic module stops the wheelchair lift when a threshold plate between the platform and the vehicle is occupied.

10. The wheelchair lift of claim 9, wherein the wheelchair lift will not automatically start again when the threshold plate becomes unoccupied.

11. The wheelchair lift of claim 1, wherein the logic module prevents the platform from being raised or lowered unless an inboard roll stop is fully raised.

12. The wheelchair lift of claim 1, wherein the logic module prevents the platform from being raised or lowered unless an inboard roll stop and an outboard roll stop are fully raised.

13. The wheelchair lift of claim 1, further including a plurality of visual alarms coupled to the wheelchair lift.

14. The wheelchair lift of claim 1, wherein the logic module stops the wheelchair lift if the logic module receives more than one command at a time from a user.

15. The wheelchair lift of claim 1, wherein the logic module is capable of displaying an error message when the proper conditions are not met.

16. A wheelchair lift for raising and lowering a passenger to and from a vehicle, the wheelchair lift comprising:
a platform capable of stowing into a stowed position;
sensor means; and
logic means coupled to the platform and the sensor means, the logic means capable of using data from the sensor means to provide an interlock which promotes the proper operation of the wheelchair lift.

17. A wheelchair lift capable of stowing from a floor level position into a stowed position, the wheelchair lift comprising:
a platform;
a lift linkage coupled to the platform; and
a stow linkage coupled to the platform and the lift linkage;
wherein when a command is received from a user to stow the wheelchair lift from the floor level position into the stowed position, the lift linkage and the stow linkage allow the platform to be lifted a short distance while the platform is maintained in a substantially level orientation;
wherein the platform stops if a weight exceeding a predetermined threshold is detected on the platform while the platform is being lifted the short distance.

18. The wheelchair lift of claim 17, wherein the short distance is 1-2 inches.

19. The wheelchair lift of claim 17, wherein the predetermined threshold in 50 pounds.

20. A method for preventing a wheelchair lift from stowing from a floor level position into a stowed position if a platform of the wheelchair lift is occupied, the method comprising:
receiving a command from a user to stow the wheelchair lift from the floor level position into the stowed position;
using an actuator coupled to the platform to lift the platform a small distance from the floor level position while maintaining the platform in a substantially level orientation;
receiving data from a sensor coupled to the actuator to detect a weight on the platform while actuating the actuator to lift the platform the small distance; and
stopping the platform if the weight exceeds a predetermined threshold.

21. The method of claim 20, wherein the actuator is a hydraulic actuator including a hydraulic pump.

22. The method of claim 21, wherein the sensor is a pressure switch coupled to the hydraulic pump.

23. The method of claim 21, wherein the sensor is a pressure transducer coupled to the hydraulic pump.

24. The method of claim 20, wherein the short distance is 1-2 inches.

25. The method of claim 20, wherein the predetermined threshold is 50 pounds.

26. A wheelchair lift having a floor level position and a ground position, the wheelchair lift comprising:
a platform;
an inboard roll stop coupled to an inboard end of the platform; and
an actuator coupled to the inboard roll stop, the actuator capable of raising and lowering the inboard roll stop, wherein the actuator fully raises the inboard roll stop before the platform leaves the floor level position to travel to the ground position.

27. The wheelchair lift of claim 26, wherein if the platform stops between the floor level position and the ground position, the actuator fully raises the inboard roll stop before the platform begins to travel.

28. A method of preventing a passenger from traveling off a platform of a wheelchair lift, the wheelchair lift having a floor level position and a ground position, the method comprising:
providing an inboard roll stop having a lowered position and a raised position, the inboard roll stop in the lowered position capable of acting as bridge between the platform and a vehicle, the inboard roll stop in the raised position capable of preventing a passenger from traveling past an inboard end of the platform;
providing an actuator coupled to the inboard roll stop, the actuator capable of lowering and raising the inboard roll stop; and
using the actuator to raise the inboard roll stop to the raised position before the platform leaves the floor level position to travel to the ground position.

29. The method of claim 28, further comprising:
using the actuator to check the position of the inboard roll stop if the platform is stopped between the floor level position and the ground position; and
if the inboard roll stop is not in the raised position, using the actuator to raise the inboard roll stop to the raised position before the platform travels.

30. A wheelchair lift, comprising:
a lift linkage;
a vertical arm coupled to the lift linkage;
a platform coupled to the vertical arm; and
a light coupled to the vertical arm, wherein the light is capable of illuminating the platform.

31. A wheelchair lift, comprising:
a lift linkage;
a vertical arm coupled to the lift linkage;
a platform coupled to the vertical arm; and
a light coupled to the platform, wherein the light is capable of illuminating the platform.
